(19) United States
(12) Patent Application Publication
(10) Pub. No.: US 2017/0374526 A1
(43) Pub. Date: Dec. 28, 2017

(54) POSITION CALCULATION USING BLUETOOTH LOW ENERGY

(71) Applicant: Nokia Technologies Oy, Espoo (FI)

(72) Inventor: Kanji KERAI, London (GB)

(21) Appl. No.: 15/525,562

(22) PCT Filed: Nov. 13, 2014
(86) PCT No.: PCT/FI2014/050858

§ 371 Date: May 9, 2017

(51) Int. Cl. H04W 4/02; G01S 5/14; G01S 1/02; H04W 4/00; G01C 21/20

(52) U.S. Cl. CPC H04W 4/027; H04W 4/008; G01C 21/20; G01S 1/022; G01S 5/14

(57) ABSTRACT

A method comprises a first device: receiving at least one Bluetooth Low Energy message transmitted from each of at least three second devices, each Bluetooth Low Energy message including data indicating a position of the respective second device (S2); measuring a radio parameter for each of the received Bluetooth Low Energy messages (S3); using the radio parameters and the data included in the messages to calculate the position of the first device (S4); and transmitting a Bluetooth Low Energy message including data indicating the position of the first device (S5). A further method comprises a third device: receiving at least one Bluetooth Low Energy message transmitted from each of at least three devices, each Bluetooth Low Energy message including data indicating a position of the respective device; measuring a radio parameter for each of the received Bluetooth Low Energy messages; using the radio parameters and the data included in the messages to calculate the position of the third device; receiving at least one Bluetooth Low Energy message transmitted by a first device and including data indicating a position of the first device; and causing display of the position of the first device relative to the third device.

### FIELD

The present disclosure relates to position calculation using Bluetooth low energy.

### BACKGROUND

Bluetooth Low Energy (BTLE) is a wireless communication technology published by the Bluetooth Special Interest Group (BT-SIG) standard as a component of Bluetooth Core Specification Version 4.0. BTLE is a lower power, lower complexity, and lower cost wireless communication protocol, designed for applications requiring lower data rates and shorter duty cycles. Inheriting the protocol stack and star topology of classical Bluetooth, BTLE redefines the physical layer specification, and involves many new features such as a very-low power idle mode, a simple device discovery, and short data packets, etc.

BTLE technology is aimed at devices requiring a low power consumption, for example devices that may operate with one or more button cell batteries such as sensors, key fobs, and/or the like. BTLE can also be incorporated into devices such as mobile phones, smart phones, tablet computers, laptop computers, desktop computers etc.

### SUMMARY OF EMBODIMENTS

Various aspects of examples of the present disclosure are set out in the claims.

A first aspect of the present disclosure provides a method comprising a first device: receiving at least one Bluetooth Low Energy message transmitted from each of at least three second devices, each Bluetooth Low Energy message including data indicating a position of the respective second device; measuring a radio parameter for each of the received Bluetooth Low Energy messages; using the radio parameters and the data included in the messages to calculate the position of the first device; and transmitting a Bluetooth Low Energy message including data indicating the position of the first device.

The method may further comprise detecting whether the first device is moving.

The detection may be performed by a motion detector in the first device.

The method may further comprise performing position calculation more frequently if it is detected that the first device transitions to a moving state.

The method may further comprise using Bluetooth Low Energy messages from a predetermined number of second devices from which strongest signals are received for calculating the position of the first device if signals are received from the predetermined number of second devices.

The predetermined number may be three.

Each of the second device(s) may have a fixed position.

The Bluetooth Low Energy message may comprise several AD structures, each of which has an associated header.

The method may comprise, after receiving an AD structure as required by the first device, terminating by the first device, receiving the remaining portion of the Bluetooth Low Energy message.

A second aspect of the present disclosure provides a method comprising a third device: receiving at least one Bluetooth Low Energy message transmitted from each of at least three devices, each Bluetooth Low Energy message including data indicating a position of the respective device; measuring a radio parameter for each of the received Bluetooth Low Energy messages; using the radio parameters and the data included in the messages to calculate the position of the third device; receiving at least one Bluetooth Low Energy message transmitted by a first device and including data indicating a position of the first device; and causing display of the position of the first device relative to the third device.

The at least three devices may include the first device.

The at least three devices may include a second device.

The method may further comprise determining the direction of the magnetic North from a magnetometer in the third device and calculating the position of the third device relative to the magnetic North.

The method may comprise causing display of the first device relative to the third device with respect to the magnetic North.

The third device may comprises one of: a mobile phone, a smart phone, a tablet computer, a laptop computer, a camera and an mp3-player.

The method may further comprising displaying the position of the first device relative to the third device on a display.

The method may comprise causing display of the position of more than one first device.

The causing display of the position of more than one first device may be selected based on an identifier contained in the Bluetooth Low Energy message transmitted by each of the more than one first device such that only the position of first devices with a selected identifier are displayed on the display.

The method may comprise using Bluetooth Low Energy messages from at least three devices with the highest values of the radio parameter for calculating the position of the third device.

The method may comprise calculating the position of the third device relative to the at least three devices transmitting the Bluetooth Low Energy messages.

The radio parameter measured may be received signal strength.

The first device may be a mobile device.

The Bluetooth Low Energy message may be a position advertising message.

The data indicating the position in the Bluetooth Low Energy message may contain the latitude and longitude of the respective device.

The Bluetooth Low Energy message may comprise several AD structures, each of which has an associated header.

The method may comprise the device, after receiving an AD structure as required by the device, terminating receiving the remaining portion of the Bluetooth Low Energy message.

A third aspect of the present disclosure provides apparatus comprising a first device, the first device comprising at least one processor, at least one memory, and computer-readable code stored on the at least one memory, wherein the computer-readable code when executed controls the at least one processor to perform a method comprising: receiving at least one Bluetooth Low Energy message transmitted from each of at least three second devices, each Bluetooth Low Energy message including data indicating a position of the respective second device; measuring a radio parameter for each of the received Bluetooth Low Energy messages; using the radio parameters and the data included in the messages to calculate the position of the first device; and transmitting a Bluetooth Low Energy message including data indicating the position of the first device.

The computer-readable code when executed may control the at least one processor to perform: detecting whether the first device is moving.

The computer-readable code when executed may control the at least one processor to detect motion of the first device is performed by a motion detector in the first device.

The computer-readable code when executed may control the at least one processor to perform position calculation more frequently if it is detected that the first device transitions to a moving state.

The computer-readable code when executed may control the at least one processor to perform: using Bluetooth Low Energy messages from a predetermined number of second devices from which strongest signals are received for calculating the position of the first device if signals are received from the predetermined number of second devices.

The Bluetooth Low Energy message may comprise several AD structures, each of which has an associated header.

The computer-readable code when executed may control the at least one processor to perform, after receiving an AD structure as required by the first device, terminating receiving the remaining portion of the Bluetooth Low Energy message.

A fourth aspect of the present disclosure provides apparatus comprising a third device, the third device comprising at least one processor, at least one memory, and computer-readable code stored on the at least one memory, wherein the computer-readable code when executed controls the at least one processor to perform a method comprising: receiving at least one Bluetooth Low Energy message transmitted from each of at least three devices, each Bluetooth Low Energy message including data indicating a position of the respective device; measuring a radio parameter for each of the received Bluetooth Low Energy messages; using the radio parameters and the data included in the messages to calculate the position of the third device; receiving at least one Bluetooth Low Energy message transmitted by a first device and including data indicating a position of the first device; and causing display of the position of the first device relative to the third device.

The at least three devices may include the first device.

The at least three devices may include a second device.

The computer-readable code when executed may control the at least one processor to perform: determining the direction of the magnetic North from a magnetometer in the third device and calculating the position of the third device relative to the magnetic North.

The computer-readable code when executed may control the at least one processor to perform: causing display of the first device relative to the third device with respect to the magnetic North.

The third device may comprise one of: a mobile phone, a smart phone, a tablet computer, a laptop computer, a camera and an mp3-player.

The computer-readable code when executed may control the at least one processor to perform: displaying the position of the first device relative to the third device on a display.

The computer-readable code when executed may control the at least one processor to perform: causing display of the position of more than one first device.

The computer-readable code when executed may control the at least one processor to cause display of the position of more than one first device is selected based on an identifier contained in the Bluetooth Low Energy message transmitted by each of the more than one first device such that only the position of first devices with a selected identifier are displayed on the display.

The computer-readable code when executed may control the at least one processor to perform: using Bluetooth Low Energy messages from at least three devices with the highest values of the radio parameter for calculating the position of the third device.

The computer-readable code when executed may control the at least one processor to perform: calculating the position of the third device relative to the at least three devices transmitting the Bluetooth Low Energy messages.

The radio parameter measured may be received signal strength.

The first device may be a mobile device.

The Bluetooth Low Energy message may be a position advertising message.

The data indicating the position in the Bluetooth Low Energy message may contain the latitude and longitude of the respective device.

The Bluetooth Low Energy message may comprise several AD structures, each of which has an associated header.

The computer-readable code when executed may control the at least one processor to perform, after receiving an AD structure as required by the third device, terminating receiving the remaining portion of the Bluetooth Low Energy message.

A fifth aspect of the present disclosure provides computer program comprising computer executable instructions, which, when executed by for a first device, causes the first device to perform: receiving at least one Bluetooth Low Energy message transmitted from each of at least three second devices, each Bluetooth Low Energy message including data indicating a position of the respective second device; measuring a radio parameter for each of the received Bluetooth Low Energy messages; using the radio parameters and the data included in the messages to calculate the position of the first device; and transmitting a Bluetooth Low Energy message including data indicating the position of the first device.

The computer executable instructions when executed may further cause a computing apparatus to detect whether the first device is moving.

The detection may be performed by a motion detector in the first device.

The computer executable instructions when executed may further cause a computing apparatus to perform position calculation more frequently if it is detected that the first device transitions to a moving state.

The computer executable instructions when executed may further cause a computing apparatus to use Bluetooth Low Energy messages from a predetermined number of second devices from which strongest signals are received for calculating the position of the first device if signals are received from the predetermined number of second devices.

The predetermined number may be three.

Each of the second device(s) may have a fixed position.

The Bluetooth Low Energy message may comprise several AD structures, each of which has an associated header.

The computer executable instructions when executed may further cause a computing apparatus to, after receiving an AD structure as required by the first device, terminate by the first device, receiving the remaining portion of the Bluetooth Low Energy message.

A sixth aspect of the present disclosure provides computer program comprising computer executable instructions, which, when executed by for a first device, causes the first device to perform: receiving at least one Bluetooth Low Energy message transmitted from each of at least three devices, each Bluetooth Low Energy message including data indicating a position of the respective device; measuring a radio parameter for each of the received Bluetooth Low Energy messages; using the radio parameters and the data included in the messages to calculate the position of the third device; receiving at least one Bluetooth Low Energy message transmitted by a first device and including data indicating a position of the first device; and causing display of the position of the first device relative to the third device.

The at least three devices may include the first device.

The at least three devices may include a second device.

The computer executable instructions when executed may further cause a computing apparatus to determine the direction of the magnetic North from a magnetometer in the third device and calculating the position of the third device relative to the magnetic North.

The computer executable instructions when executed may further cause a computing apparatus to cause display of the first device relative to the third device with respect to the magnetic North.

The third device may comprises one of: a mobile phone, a smart phone, a tablet computer, a laptop computer, a camera and an mp3-player.

The computer executable instructions when executed may further cause a computing apparatus to comprise displaying the position of the first device relative to the third device on a display.

The computer executable instructions when executed may further cause a computing apparatus to cause display of the position of more than one first device.

The causing display of the position of more than one first device may be selected based on an identifier contained in the Bluetooth Low Energy message transmitted by each of the more than one first device such that only the position of first devices with a selected identifier are displayed on the display.

The computer executable instructions when executed may further cause a computing apparatus to use Bluetooth Low Energy messages from at least three devices with the highest values of the radio parameter for calculating the position of the third device.

The computer executable instructions when executed may further cause a computing apparatus to calculate the position of the third device relative to the at least three devices transmitting the Bluetooth Low Energy messages.

The radio parameter measured may be received signal strength.

The first device may be a mobile device.

The Bluetooth Low Energy message may be a position advertising message.

The data indicating the position in the Bluetooth Low Energy message may contain the latitude and longitude of the respective device.

The Bluetooth Low Energy message may comprise several AD structures, each of which has an associated header.

The computer executable instructions when executed may further cause a computing apparatus to, after receiving an AD structure as required by the device, terminate receiving the remaining portion of the Bluetooth Low Energy message.

A seventh aspect of the present disclosure provides a non-transitory computer-readable storage medium having stored thereon computer-readable code, which, when executed by computing apparatus causes the computing apparatus to perform a method comprising: receiving at least one Bluetooth Low Energy message transmitted from each of at least three second devices, each Bluetooth Low Energy message including data indicating a position of the respective second device; measuring a radio parameter for each of the received Bluetooth Low Energy messages; using the radio parameters and the data included in the messages to calculate the position of the first device; and transmitting a Bluetooth Low Energy message including data indicating the position of the first device.

An eighth aspect of the present disclosure provides a non-transitory computer-readable storage medium having stored thereon computer-readable code, which, when executed by computing apparatus causes the computing apparatus to perform a method comprising: receiving at least one Bluetooth Low Energy message transmitted from each of at least three devices, each Bluetooth Low Energy message including data indicating a position of the respective device; measuring a radio parameter for each of the received Bluetooth Low Energy messages; using the radio parameters and the data included in the messages to calculate the position of the third device; receiving at least one Bluetooth Low Energy message transmitted by a first device and including data indicating a position of the first device; and causing display of the position of the first device relative to the third device. Bluetooth Low Energy or BTLE as used herein denotes Bluetooth Core Specification Version 4.0 or later versions that are backwards-compatible with Version 4.0. A BTLE device or component is a device or component that is compatible with Bluetooth Core Specification Version 4.0.

### BRIEF DESCRIPTION OF THE DRAWINGS

For a more complete understanding of example embodiments of the present disclosure, reference is now made to the following descriptions taken in connection with the accompanying drawings in which:

FIG. 1 is a schematic diagram of a BTLE position advertising message used in embodiments of the present disclosure;

FIG. 2 is a schematic diagram of a system according to aspects of the present disclosure including components according to aspects of the present disclosure and operating according to aspects of the present disclosure;

FIG. 3 is a flow chart illustrating operation of a BTLE mobile tag included in the system of FIG. 1 according to an embodiment of the present disclosure;

FIG. 4 is a flow chart illustrating operation of a terminal device included in the system of FIG. 1 according to embodiments of the present disclosure;

FIG. 5(a) is an exemplary screen of a display device indicating the general direction of a mobile tag relative to a terminal device according to embodiments of the present disclosure;

FIGS. 5(b) and 5(c) show the exemplary screen rotated;

FIG. 6(a) is an exemplary screen of a display device indicating the general directions of two mobile tags relative to a terminal device according to embodiments of the present disclosure;

FIGS. 6(b) and 6(c) show the sequential display of the general directions of the two mobile tags;

FIG. 7(a) is an exemplary screen of a display device indicating the coordinates of two mobile tags relative to a terminal device according to embodiments of the present disclosure; points are shown in the Cartesian plane;

FIG. 7(b) is an exemplary screen of a display device indicating the locations of two mobile tags relative to a reference point shown in Polar coordinates according to embodiments of the present disclosure;

FIG. 8(a) is an exemplary screen of a display device indicating the coordinates of multiple mobile tags relative to a terminal device according to embodiments of the present disclosure;

FIGS. 8(b) and 8(c) show exemplary screens of a display device selectively displaying the coordinates of multiple mobile tags relative to a reference point according to embodiments of the present disclosure;

FIG. 9 is a schematic diagram of a network cloud system according to aspects of the present disclosure including components according to aspects of the present disclosure and operating according to aspects of the present disclosure;

FIG. 10 is an exemplary screen of a display device indicating the coordinates of mobile tags in multiple areas relative to a terminal device according to embodiments of the present disclosure.

FIG. 11 is a schematic diagram of a network cloud system according to aspects of the present disclosure including a collector device according to aspects of the present disclosure and operating according to aspects of the present disclosure; and

FIG. 12 is an exemplary non-transitory computer readable storage medium according to embodiments of the present disclosure.

### DESCRIPTION

Bluetooth Low Energy (BTLE) technology has been proposed to be used in indoor positioning systems for tracking devices. Such systems involve the use of High Accuracy Indoor Positioning (HAIP) which places requirements on hardware infrastructure such as the need for multiple array antennas. Therefore this makes for a simpler and more efficient system that is easier to implement using BTLE hardware technology that is already available in the market. The principles of BTLE are described in the art. BTLE devices broadcast BTLE messages that are associated with profiles, services and protocols as defined by the BTLE standard. Information is transmitted in a BTLE message in a series of AD structures. Each of these AD structures contain a header portion and a payload portion. The header portion describes the type of data present in the payload portion and the size of said data.

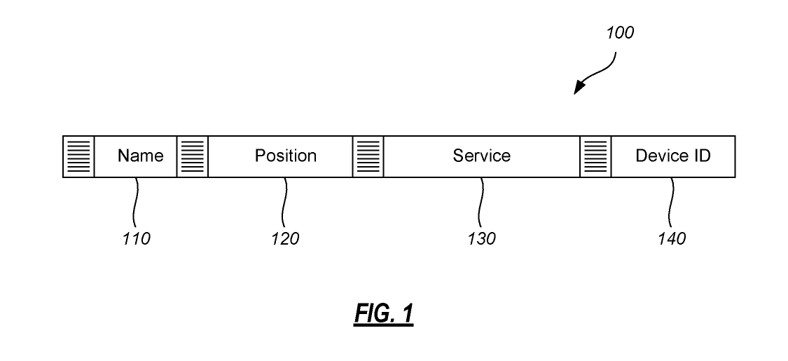

An exemplary BTLE message 100 is shown in FIG. 1. This BTLE message contains four AD structures: device name 110, device position 120, service 130 and a manufacturer ID 140.

As the BTLE message can be large, the BTLE message need not be received by a receiving device in entirety; the receiving device has the option to stop receiving the rest of a BTLE message once the AD structures containing the required data of the BTLE message have been received by the receiving device.

A BTLE message transmitted by a BTLE device (fixed tag) is received by a further BTLE device (mobile tag), which measures a radio parameter associated with the BTLE message. Examples of a radio parameter are Received Signal Strength Indicator (RSSI) or the Bit Error Rate (BER). With the position data 120 contained in the BTLE message 100 and the RSSI value of that message, the mobile tag is able to calculate a locus of its position relative to the fixed tag. The position of the mobile tag can be better resolved when BTLE messages from more fixed tags are received by the mobile tag. This enables the mobile tag to calculate a further locus of its position relative to each additional fixed tag. The mobile tag then calculates the intersection of these loci to obtain its accurate position relative to the fixed tags. This calculated position is then further transmitted by the mobile tag as a BTLE message. Consequently this transmitted BTLE message can be used by other BTLE devices for tracking and displaying purposes.

It will be understood that in order to obtain an accurate calculation of the position of a mobile tag relative to fixed tags, at least three of such fixed tags are required. The calculation of the position of a mobile tag is not so accurate if data from one or two fixed tags are used.

In an exemplary embodiment of the present disclosure, the mobile tag may calculate the locus of its position relative to the fixed tags using a circle method or a midpoint method.

In the circle method, the RSSI values associated with each of the three BTLE messages are used to determine radii of three circles, the centres of each being pinned to the location of the respective fixed tag. The locus of the position of the mobile tag relative to the fixed tags is then determined from the area of overlap of these circles.

The midpoint method is a faster method for calculating the position of the mobile tag relative to the fixed tags. This involves using predetermined ratios of RSSI values associated with each BTLE message to calculate intermediate points on lines that join the respective fixed tags. The position of the mobile tag relative to the fixed tags is then determined by calculating the midpoint of the line that connects the intermediate points.

It should be noted that while the circle or midpoint methods have been described, other methods of calculating the position of a mobile tag relative to the fixed tags may be used.

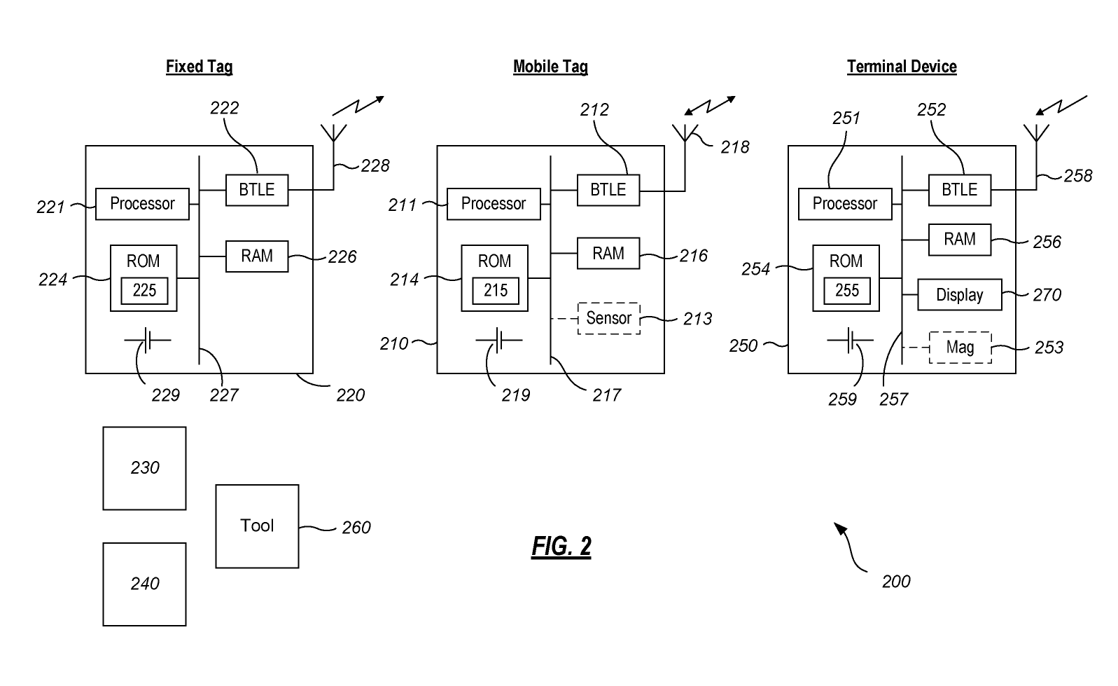

FIG. 2 shows a system 200 according to embodiments of the present disclosure. The system 200 includes a mobile tag 210, three fixed tags 220, 230 and 240, and a terminal device 250. The mobile tag 210 and the terminal device 250 are portable and their locations can be tracked.

The BTLE fixed tags 220, 230, 240 are based at different locations within a building or complex of buildings and periodically transmit BTLE messages. These messages are BTLE positioning advertisement messages. These messages contain positioning data relating to the specific fixed tag that has transmitted the message. The BTLE messages transmitted by the specific fixed tag also include an identifier that is unique to the transmitting device within the building. Thus, for example, BTLE messages transmitted from fixed tag 220 contains positioning data and an identifier that are unique to that device.

The positioning advertisement messages include data identifying the location of each of the fixed tags 220, 230 and 240. The location of each of the fixed tags 220, 230 and 240 can be given, for example, in Cartesian coordinates, Polar coordinates or Spherical coordinates.

Each of the mobile tag 210 and the terminal device 250 receives BTLE messages transmitted from each of the fixed tags 220, 230 and 240. The mobile tag 210 and the terminal device 250 then measure a radio parameter associated with each received message; this is in the form of an RSSI value, for example. With the positioning data and the measured RSSI values associated with BTLE messages received from all fixed tags 220, 230 and 240, the mobile tag 210 and the terminal device 250 each respectively calculate its location relative to each of the fixed tags 220, 230 and 240.

BTLE messages transmitted from each of the fixed tags 220, 230 and 240, are first received by the mobile tag 210. The mobile tag 210 decodes the position data relating to the location of a fixed tag 220 contained in the BTLE position advertising message transmitted from the fixed tag 220. The mobile tag 210 measures the RSSI value of the BTLE message received from the fixed tag 220, and calculates a locus of its position relative to the fixed tag 220. The same method of calculation is repeated for BTLE messages transmitted from each of the remaining fixed tags 230 and 240. The intersection of the loci obtained from the fixed tags 220, 230 and 240 is then calculated by the mobile tag 210. This gives an accurate position of the mobile tag 210 relative to each of the fixed tags 220, 230 and 240.

With respect to the terminal device 250, BTLE position advertising messages transmitted from at least three BTLE devices are received by the terminal device 250. These at least three BTLE devices may by selected from any of the mobile tag 210 and the fixed tags 220, 230 and 240. The terminal device 250 detects the positioning data contained in the BTLE messages along with the unique identifier associated with the device from which the respective BTLE message was transmitted. The RSSI value associated with each BTLE message is also measured. The terminal device 250 then calculates its position relative to devices from which the BTLE messages were transmitted. The terminal device 250 then scans for position advertising messages transmitted from a mobile tag 210. The terminal device 250 uses these messages to then create image data representative of the position of the mobile tag 210 relative to the terminal device 250. The terminal device 250 then uses this image data to cause display of the position of the mobile tag 210 relative to the position of the terminal device 250.

It will be understood that there may be more than one mobile tag 210 present. In this case the terminal device 250 obtains position advertising messages transmitted from all the mobile tags 210 and creates image data representative of the position of each of said mobile tags 210 relative to the terminal device 250. The terminal device 250 then uses this image data to cause display of the position of the mobile tags 210 relative to the position of the terminal device 250.

Referring to FIG. 2, the mobile tag 210 includes a BTLE module 212, which operates according to the Bluetooth Low Energy standard. Each of the fixed tags 220, 230 and 240 also includes a BTLE module 212 that operates according to the Bluetooth Low Energy standard.

The mobile tag 210 includes a processor 211. The processor 211 is connected to volatile memory such as RAM 216 by a bus 217. The bus 217 also connects the processor 211 and the RAM 216 to non-volatile memory, such as ROM 214. A BTLE module 212 is coupled to the bus 217, and thus also to the processor 211 and the memories 214, 216. An antenna 218 is coupled to the BTLE module 212, although each may instead have its own antenna. Within the ROM 214 is stored a software application 215. The software application 215 in these embodiments is an application for calculating a position of the mobile tag 210 and for forming position advertising messages.

The mobile tag 210 also includes a source of power 219. The source of power 219 may be for instance a battery such as a coin cell. The source of power 219 powers the BTLE module 212 and any other components of the mobile tag 210. The mobile tag 210 may optionally include a sensor 213 for detecting any movement of the mobile tag 210.

The mobile tag 210 may take any suitable form. Generally speaking, the mobile tag 210 may comprise processing circuitry 211, including one or more processors, and a storage device 214, 216, comprising a single memory unit or a plurality of memory units. The storage device 214, 216 may store computer program instructions 215 that, when loaded into the processing circuitry 211, control the operation of the mobile tag 210.

The BTLE module 212 may take any suitable form. Generally speaking, the BTLE module 212 of the mobile tag 210 may comprise processing circuitry, including one or more processors, and a storage device comprising a single memory unit or a plurality of memory units. The storage device may store computer program instructions that, when loaded into the processing circuitry, control the operation of the BTLE module 212.

The BTLE module 212 includes a communication stack that is implemented at least partly in software using processor and memory resources (not shown), all of which are included within the BTLE module 212. The BTLE module 212 is configured, when enabled by the processor 211 running application 215, to receive the positioning data contained in incoming position advertising messages, and to report said data to the processor 211. The processor 211 calculates the position of the mobile tag 210 relative to the fixed tags 220, 230 and 240 from which the position advertising messages were transmitted. The BTLE module 212 then embeds this calculated position of the mobile tag 210 in a BTLE message as positioning data of the mobile tag 210, along with an identifier unique to the mobile tag 210. The BTLE message is then transmitted from the mobile tag 210 via the antenna 218.

The BTLE module 212 of the mobile tag 210 is both a transmitter and a receiver.

Each of the fixed tags 220, 230 and 240 includes a BTLE module 222, an antenna 228, a source of power 229, a processor 221, RAM 226, ROM 224 containing computer readable instructions and a bus 227, which are constituted and connected in any suitable way. The ROM 224 of each of the fixed tags 220, 230 and 240 also stores information 225. The to information 225 includes the location of the fixed tag 220, 230 and 240, and a unique identifier. Information 225 may be written to each of the fixed tags 220, 230 and 240 using an external tool 260 connected to each fixed tag 220, 230 and 240 through the BTLE module 222 thereof.

Each of the fixed tags 220, 230 and 240 may take any suitable form. Generally speaking, these devices may comprise processing circuitry, including one or more processors, and a storage device, comprising a single memory unit or a plurality of memory units. The storage device may store computer program instructions that, when loaded into the processing circuitry, control the operation of the fixed tag 220, 230 and 240 (such as the frequency of transmission of position advertising messages).

Each of the fixed tags 220, 230 and 240 may be configured to operate in the same way. However these devices may differ in that the information 225 stored in the ROM 224 includes a different identifier and a different location for each of the fixed tags 220, 230 and 240. The identifier and location data of each of the fixed tags 220, 230 and 240 are included in the position advertising messages transmitted from each of the fixed tags 220, 230 and 240.

The source of power 229 may be for instance a battery such as a coin cell. The source of power 229 powers the BTLE module 222 and any other components of each of the fixed tags 220, 230 and 240.

The BTLE module 222 of each of the fixed tags 220, 230 and 240 is a transmitter.

As with the mobile tag 210, the terminal device 250 includes a processor 251. The processor 251 is connected to volatile memory such as RAM 256 by a bus 257. The bus 257 also connects the processor 251 and the RAM 256 to a non-volatile memory, such as ROM 254. A BTLE module 252 is coupled to the bus 257, and thus also to the processor 251 and the memories 254, 256. An antenna 258 is coupled to the BTLE module 252. A software application 255 is stored within the ROM 254. The software application 255 is an application for causing a display of the mobile tag 210 relative to a reference point, although it may take some other form.

The terminal device 250 may optionally include a magnetometer 253 for determining the orientation of the terminal device 250 with respect to the magnetic North.

The BTLE module 252 of the terminal device is a receiver, and may also be a transmitter.

The terminal device 250 may be a mobile phone, a smart phone, a tablet computer, a laptop computer, a camera, an mp3-player, or equipment integrated within vehicles, etc.

As the mobile tag 210 and the terminal device 250 calculate their respective positions relative to the fixed tags 220, 230 and 240 using BTLE messages, the use of a wired network is not required.

Positioning advertisement messages may be transmitted by each of the fixed tags 220, 230 and 240 periodically, for instance at 4 Hz (250 millisecond intervals) or at intervals defined by some component within the system. They may alternatively be transmitted on request of some component within the system. In BTLE, advertisement messages are called ADV_IND. Each includes a packet data unit (PDU), called an ADV_IND PDU.

In this specification, the terms ‘message’ and ‘packet’ are used interchangeably since they are intrinsically linked.

Devices 210, 250 can calculate their positions with the same periodicity with which the position advertising messages are transmitted by the fixed tags 220, 230 and 240. The calculated position of mobile tag 210 is embedded in a BTLE position advertising message which is then transmitted by the antenna 218. Position advertising messages are transmitted by the mobile tag 210 periodically, for example every second. However this periodicity increases if the mobile tag 210 is moving. Motion of the mobile tag 210 is detected by the sensor 213.

If there are more than three fixed tags, embodiments of the present disclosure provide for the detection of motion of the mobile tag 210 using the BTLE messages received from the fixed tags, regardless of whether the mobile tag 210 has a motion sensor 213. If all messages received from the more than three fixed tags are the same at each period except for the messages from one of the more than three fixed tags, the mobile tag is determined to be not moving; the difference in message from the one fixed tag of the more than three fixed tags may be due to attenuation of the signal from that fixed tag (due to, for example, a person walking through the path between the fixed tag in question and the mobile tag).

The computer program instructions 215 in the mobile tag 210 may provide the logic and routines that enables the mobile tag 210 to perform the functionality described. The computer program instructions 215 may be pre-programmed into the mobile tag 210.

The processing circuitry 211, 221, 251 may be any type of processing circuitry. For example, the processing circuitry may be a programmable processor that interprets computer program instructions and processes data. The processing circuitry may include plural programmable processors. Alternatively, the processing circuitry may be, for example, programmable hardware with embedded firmware. The processing circuitry or processor 211, 221, 251 may be termed processing means.

Typically, the BTLE modules 212, 222 and 252 each comprise a processor connected to both volatile memory and non-volatile memory. The computer program is stored in the non-volatile memory and is executed by the processor using the volatile memory for temporary storage of data or data and instructions.

The term ‘memory’ when used in this specification is intended to relate primarily to memory comprising both non-volatile memory and volatile memory unless the context implies otherwise, although the term may also cover one or more volatile memories only, one or more non-volatile memories only, or one or more volatile memories and one or more non-volatile memories. Examples of volatile memory include RAM, DRAM, SDRAM etc. Examples of non-volatile memory include ROM, PROM, EEPROM, flash memory, optical storage, magnetic storage, etc.

Each BTLE module 212, 222, 252 may be a single integrated circuit. Each may alternatively be provided as a set of integrated circuits (i.e. a chipset). The BTLE modules 212, 222, 252 may alternatively be hardwired, application-specific integrated circuits (ASIC).

The fixed tags 220, 230, 240 are distributed around a building or premises. For instance these devices may be located at various points in a hospital or warehouse so as to provide sufficient coverage of the premises. While the above description details three fixed tags 220, 230, 240, this is a minimum number of fixed tags required and any number of such devices can be employed.

Embodiments of the present disclosure provide a scheme whereby a BTLE mobile tag 210 is located by a terminal device 250, with the aid of at least three fixed tags 220, 230, 240, without the need for a network. The terminal device 250 causes a display of the mobile tag 210 relative to the position of the terminal device 250, so as to inform or guide a user. In relation to the following description, it will be understood that there may be more than one mobile tag 210 present.

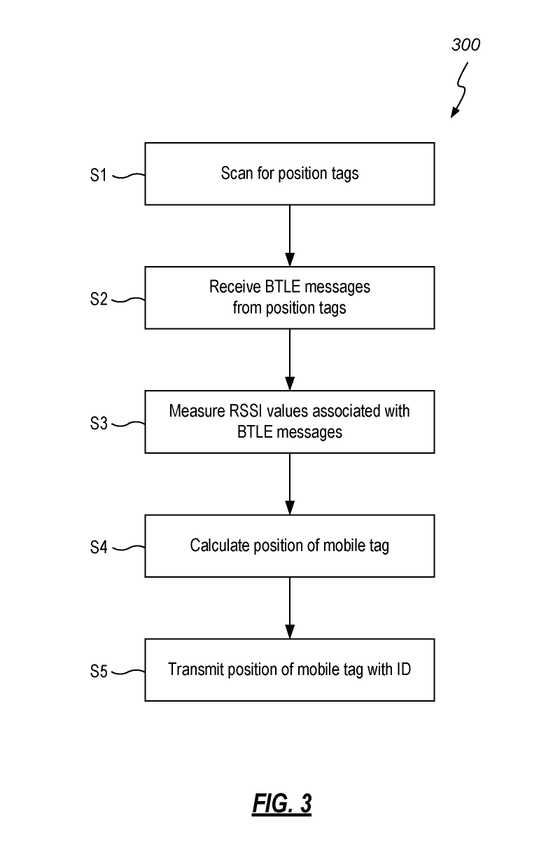

A first method 300 according to the present disclosure will now be described with respect to FIG. 3 and mostly with reference to the mobile tag 210. The steps carried out by the mobile tag are performed by the processor 211 using the RAM 216 under control of the software application 215 stored in the ROM 214. Steps performed by the fixed tags 220, 230 and 240 involve the corresponding components.

The operation starts at step S1. Here the mobile tag 210 scans for BTLE position advertising messages that are transmitted by any of the fixed tags 220, 230 and 240 as described above. The software application 215 stored in ROM 214 of the mobile tag 210 specifies the manner in which the scanning operation takes place, the frequency of scanning, and the width of the scanning window. Within the scanning window, the processor 211 instructs the BTLE module 212 in the mobile tag 210 to detect position advertising messages that impinge upon the antenna 218.

At step S2, the BTLE module 212 receives position advertising messages that are transmitted by BTLE devices within the scanning window. The processor 112 then determines if the received messages were transmitted by any of the fixed tags 220, 230 and 240. Here the BTLE module 212 in the mobile tag 210 determines the value of an identifier contained in a received position advertising message by checking its header section. The BTLE module 212 then passes this value to the processor 211. The processor 211, using software application 215, compares this value with parameters set by the software application 215. Only position advertising messages transmitted with identifiers that correspond to ‘allowed’ fixed tags 220, 230 and 240 are received and subsequently stored in the RAM 216.

At step S3, when the processor 211 confirms that a received BTLE position advertising message has been transmitted by an ‘allowed’ fixed tag 220, 230 and 240, it instructs the BTLE module 212 to record a radio parameter associated with said received message. This parameter is the RSSI value. The received position advertising message, the associated RSSI value, and the unique identifier of the fixed tag 220, 230 and 240 from which the message was transmitted are stored in the RAM 216 of the mobile tag 210.

The processor 211 instructs the BTLE module 212 to scan for BTLE position advertising messages transmitted from fixed tags 220, 230 and 240 that have position advertising messages that are received by the BTLE module 212 from at least three fixed tags 220, 230 and 240.

At step S4, the processor 112 uses the position data contained in each of the received position advertising messages from the fixed tags 220, 230 and 240, and their respective RSSI values, to calculate the location of the mobile tag 210 relative to the fixed tags 220, 230 and 240 from which the position data was obtained. Location calculation may be done using any of the previously described methods. This leads to accurate calculation of the position of the mobile tag 210 which uses less battery power.

If there are more than three fixed tags 220, 230 and 240 transmitting position advertising messages which have been consequently received by the BTLE module 212 of the mobile tag 210, the processor 211 may only uses the position data stored in the RAM 216 that corresponds to the three position advertising messages that have the highest RSSI values for the calculation step S4.

Position determination by the processor 211 may be performed at any suitable frequency. The positions so determined may be filtered in any suitable way so as to minimise effects of external factors, such as a person walking through the path between the transmitter and the receiver.

At step S5, the processor 211 instructs the BTLE module 212 to transmit the calculated location of the mobile tag 210 relative to the fixed tags 220, 230 and 240 via the antenna 218 as a BTLE position advertising message.

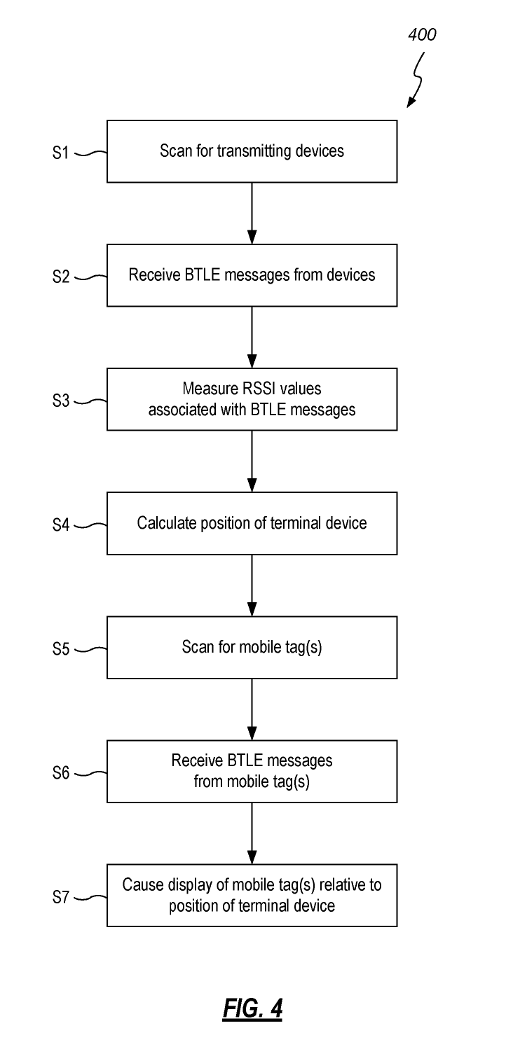

A second method 400 according to the present disclosure will now be described with respect to FIG. 4, and mostly with reference to the terminal device 250. The steps carried out by the terminal device 250 are performed by the processor 251 using the RAM 256 under control of a software application 255 stored in the ROM 254. Steps performed by the mobile tag 210 and by fixed tags 220, 230 and 240 involve the corresponding components.

The method begins at step S1. As with the previously described method, here the terminal device 250 scans for BTLE position advertising messages that are transmitted by BTLE devices. These devices could be any of the mobile tag 210 and the fixed tags 220, 230 and 240. The software application 255 stored in ROM 254 of the terminal device 250 specifies the manner in which the scanning operation takes place, the frequency of scanning, and the width of the scanning window. Within the scanning window, the processor 251 instructs the BTLE module 252 to detect position advertising messages that impinge upon the antenna 258.

At step S2, the BTLE module 252 receives position advertising messages that are generally transmitted by BTLE devices within the scanning window. The processor 251 then determines the source of the position advertising messages; this could be any of the mobile tag 210 and the fixed tags 220, 230 and 240. The BTLE module 252 in the terminal device 250 determines the value of an identifier contained in a received position advertising message by checking its header section. The BTLE module 252 then passes this value to the processor 251. The processor 251, using software application 255, compares this value with parameters set by the software application 255. Only position advertising messages transmitted with identifiers that correspond to ‘allowed’ BTLE devices are received and subsequently stored in the RAM 256.

At step S3, when the processor 251 confirms that a received BTLE position advertising message has been transmitted by an ‘allowed’ BTLE device, it instructs the BTLE module 252 to record a radio parameter associated with said received message. This radio parameter is the RSSI value of the received message. The received position advertising message, the associated RSSI value, and the unique identifier of the BTLE device from which the message was transmitted are stored in the RAM 256 of the terminal device 250.

At step S4, the processor 251 uses the location data contained in each of the position advertising messages received from at least three BTLE devices, and the measured RSSI values corresponding to each message, to calculate the location of a reference point relative to the BTLE devices from which the position advertising messages originated; these devices could be any of the mobile tag 210 and the fixed tags 220, 230 and 240. This reference point corresponds to the position of the terminal device 250 relative to the BTLE devices from which the position advertising messages originated.

If there are more than three BTLE devices transmitting position advertising messages which have been consequently received by the BTLE module 252 of the terminal device 250, the processor 251 may only uses the location data stored in the RAM 256 that corresponds to the three position advertising messages that have the highest RSSI values for the calculation step S4.

The location data corresponding to the reference point is stored in the RAM 256 of the terminal device 250.

At step S5, the terminal device 250 scans for BTLE position advertising messages that are transmitted by the mobile tag 210. The software application 255 specifies the manner in which the scanning operation takes place, the frequency of scanning, and the width of the scanning window. Within the scanning window, the processor 251 instructs the BTLE module 252 to detect position advertising messages that impinge upon the antenna 258 that have been transmitted by the mobile tag 210. The BTLE module 252 does this by reading the headers of the position advertising messages that impinge upon antenna 258. The processor 251 then compares an identifier in said header with a value that has been allocated to the ROM 254 by the application 255. Only position advertising messages transmitted with identifiers that correspond to ‘allowed’ mobile tags 210 are received and subsequently stored in the RAM 256.

At step S6, when the processor 251 confirms that a received BTLE position advertising message has been transmitted by an ‘allowed’ mobile tag 210, it instructs the BTLE module 252 to measure a radio parameter associated with said received message. This radio parameter is the RSSI value of the received message. The location data in the received position advertising message, the associated RSSI value, and the unique identifier of the mobile tag 210 from which the message was transmitted are stored in the RAM 256 of the terminal device 250 as a position vector. If the scanning step S5 continues and the terminal device 250 captures position data from more than one mobile tag 210, the RAM 256 may contain several position vectors, each of which corresponds to a different mobile tag 210.

At step S7, the processor 215 accesses the RAM 256 and uses the data associated with each location vector to enable the display of the mobile tag(s) relative to the reference point.

This may be in the form of image data that is output from the processor 251 to a display 270. The image data therefore contains information relating to the location of the reference point and the relative locations of the mobile tag(s) 210 at that instant. This image data is updated at regular intervals where any new position data corresponding to the position of the mobile tag 210 or the reference point is re-calculated using the methods described above, and updated image data is then output to the display 270. The software application 255 specifies the frequency with which the updating occurs.

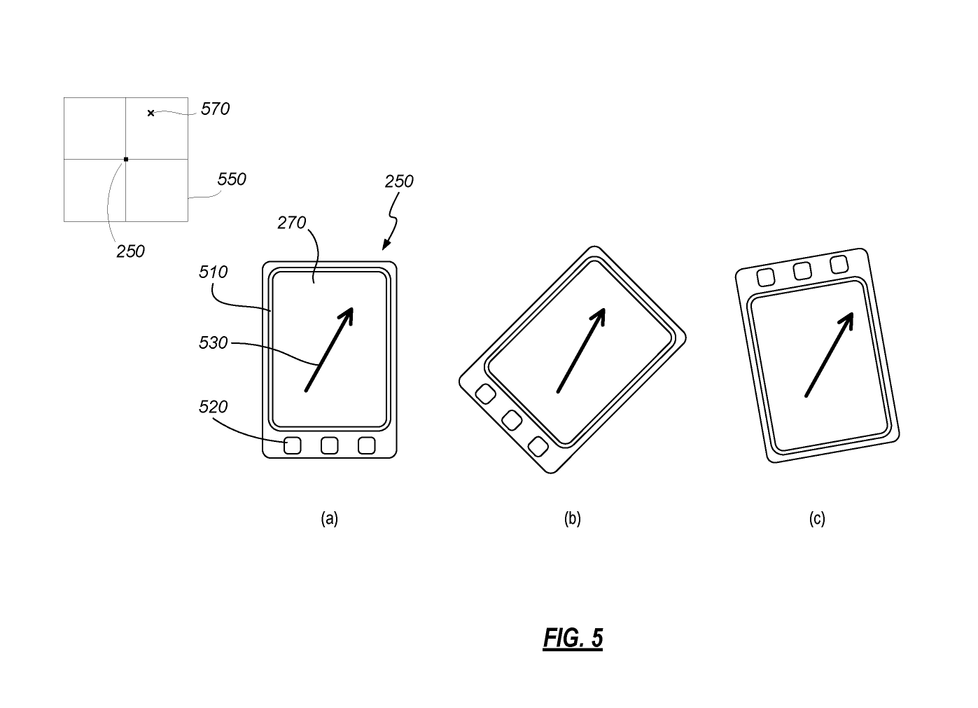

FIG. 5(a) shows an exemplary terminal device 250 with a display 270. The terminal to device 250 may be a tablet computer, a laptop computer, a smart phone, or equipment integrated within vehicles. The display 270 comprises a screen 510 and a plurality of input buttons 520.

The display 270 is configured to receive the image data generated by the processor 251. The display 270 graphically represents the received image data. This enables a user to view the location of one or more mobile tags 210 relative to the terminal device 250.

This graphical representation may be in the form of an indicated general direction of the mobile tag(s) 210 from the terminal device 250, or specific coordinates from the reference point. These coordinates may be Cartesian coordinates or Polar coordinates.

The simplest form of indication involves the display 270 presenting the user with an arrow 530 to indicate the direction in which a mobile tag 210 is located relative to the terminal device 250, as shown in FIG. 5(a). Here the image data received by the display 270 is representative of an area 550 containing a terminal device 250 and one mobile tag 570. The area 550 is a physical space which contains the mobile tag(s) and the terminal device. The arrow 530 only indicates the direction of the mobile tag 570 in relation the terminal device 250. This graphical representation shows the bearing of the mobile tag 570 from the terminal device 250; no distance is indicated. When the display 270 is rotated (such as in FIGS. 5(b) and 5(c)), the angular placement of the arrow 530 relative to the terminal device 250 does not change. This assumes that the mobile tag 570 has not changed position as the display 270 is rotated as in FIGS. 5(b) and 5(c).

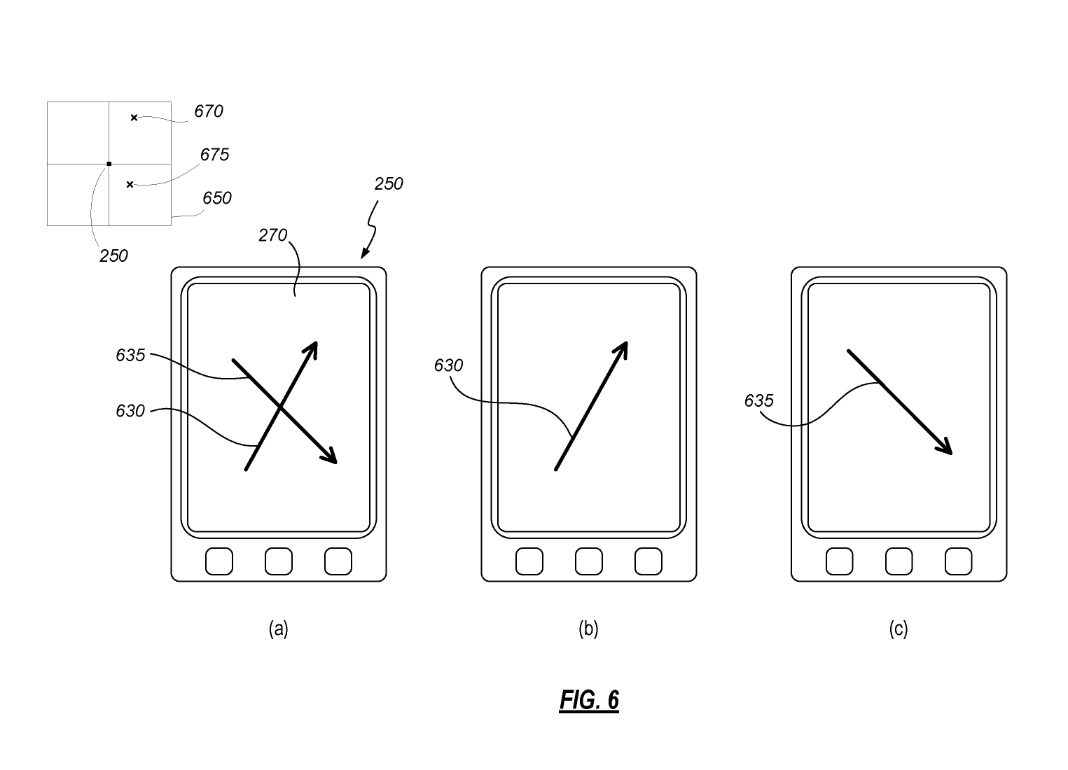

If more than one mobile tag is present in the area, the display either displays two arrows on its display, as shown in FIG. 6(a), or plays an animation of a first arrow followed by a second arrow, as shown in FIGS. 6(b) and 6(c). Here the imagining data received by display 270 is representative of an area 650 containing a terminal device 250 and two mobile tags 670 and 675. In FIG. 6(a), the display 270 displays two arrows 630 and 635. Arrow 630 indicates the direction of the mobile tag 670 in relation to the terminal device 250, while arrow 635 indicates the direction of the mobile tag 675 in relation to the terminal device 250.

Alternatively, the display may display the two arrows sequentially. This is shown in FIGS. 6(b) and 6(c) in relation to the area 650 as described above. Here display 270 first displays arrow 630, in a first instance, as shown in FIG. 6(b). Arrow 630 indicates the direction of the mobile tag 670 in relation to the terminal device 250. The display 270 then sequentially displays arrow 635, in a second instance, as shown in FIG. 6(c). Arrow 635 indicates the direction of the mobile tag 675 in relation to the terminal device 250.

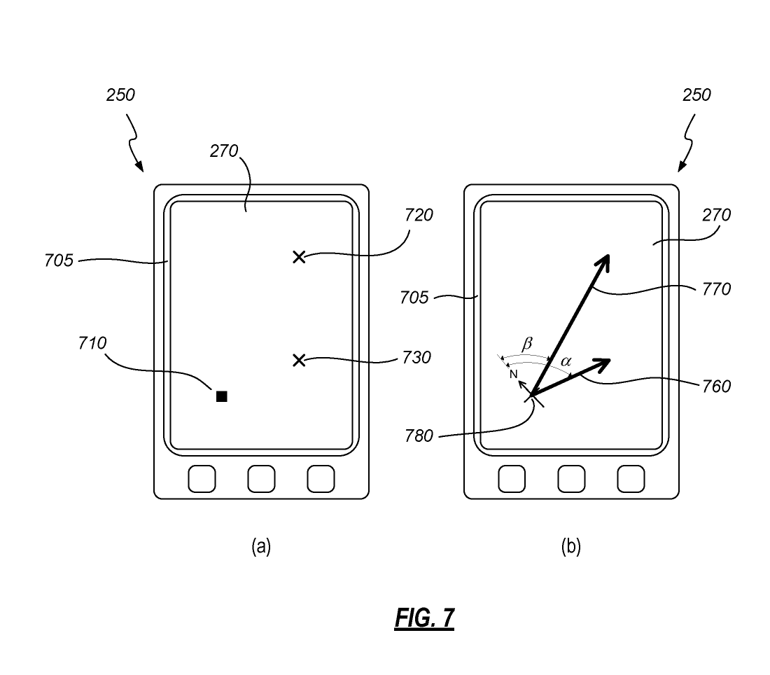

The graphical representation on the display could also take the form of specific coordinates. Here both the direction and distance of the mobile tag(s) from the terminal is device 250 are indicated on the display 270. FIG. 7(a) shows the display of two mobile tags 210 represented as crosses 720 and 730 and a terminal device 250 represented as a square 710 on a display 270 in a Cartesian coordinate system. In Cartesian coordinates, the latitude and longitude of the mobile tag(s) relative to the terminal device 250 is visually presented on the screen 705 of the display 270. The square 710 indicates the position of the terminal device 250, while the crosses 720 and 730 indicate the relative position of the respective mobile tags 210 with respect to the position of the terminal device 250. A user holding a terminal device 250 is therefore instantly graphically provided with location information of the two mobile tags 210 represented by crosses 720 and 730 in relation to the user's position (i.e. the position of the terminal device 250), thereby enabling the user to find his or her direction within an area.

FIG. 7(b) illustrates a display of the location of two mobile tags 210 represented as arrows 760 and 770, and the location of the terminal device 250 represented as a reference marker 780, on the display 270 in a Polar coordinate system. The reference marker 780 in this case is a compass point indicating North as determined from a magnetometer 253 in the terminal device 250. The compass North is a direction from which all bearings are measured. Thus in this case, the bearing of a mobile tag 210 as indicated by arrow 760 is measured from the compass North, as shown by the angle α. The length of arrow 760 indicates the distance between the terminal device 250 and the mobile tag 210. Similarly, the bearing of a further mobile tag 210 as indicated by arrow 770 is measured from the compass North and is shown by the angle θ. The length of arrow 770 indicates the distance between the terminal device 250 and the further mobile tag 210.

In various embodiments of the present disclosure, the floorplan of a building may be additionally displayed by the display in relation the previously described display techniques. This floorplan will be of an area of the building within which the BTLE devices are located, and would be within the area covered by the terminal device. The reference point and the points corresponding to the relative location of the mobile tag(s) are superimposed onto the display of the floorplan. This allows a user having a terminal device 250 to navigate his or her way around the building with ease when tracking a mobile tag 210.

Alternatively, the data relating to the position vectors stored in the RAM 320 of the terminal device 250 could be output to a display 270 which displays this data as text to a user. Such text may present the user with the numerical coordinates of the mobile tag(s) 210 in relation to the position of the terminal device 250.

The information contained in the header portion of each data packet of the position advertising messages can be used to selectively display position data according to various criteria. These criteria may be based on an identifier value contained in the data packets. In relation to the example provided in FIG. 1, the position data may be selected according to the device name, the manufacturer ID or the service, for example. In this manner, the display will only display the position of mobile tags that meet the selection criteria (i.e. mobile tags which have position data that contains the selected identifier value).

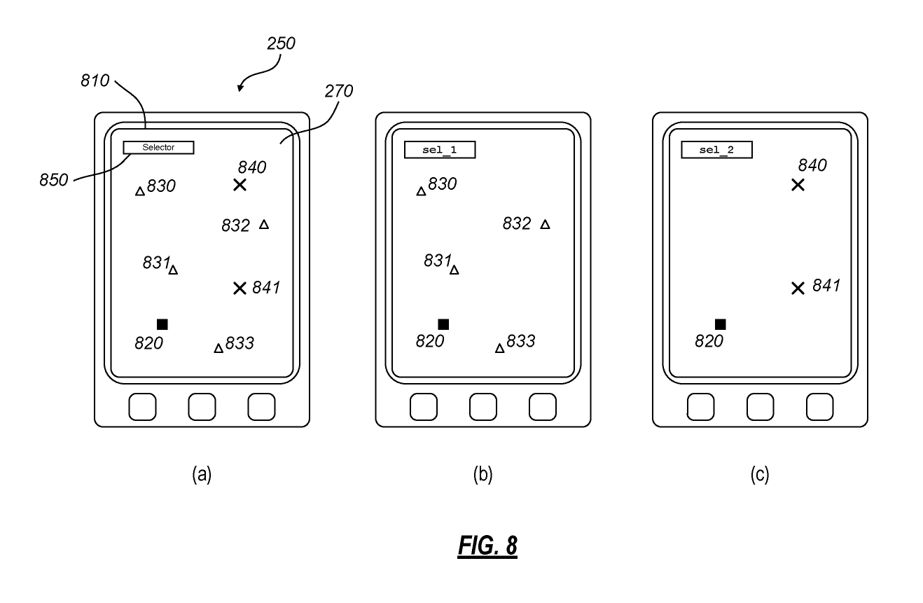

FIG. 8(a) illustrates an exemplary display 270 of a terminal device 250. The display 270 comprises at least a screen 810. The screen 810 displays the position of the terminal device 250 as point 820, points corresponding to mobile tags 210 of a first type 830, 831, 832, and 833, and points corresponding to mobile tags of a second type 840 and 841. The first type of mobile tag may have a different identifier value to the second type of mobile tag. For example the first identifier type may be for mobile tags which are attached to patients in a hospital, while the second identifier type may be for mobile tags which are attached to nurses in the same hospital. In the example shown in FIG. 8(a), mobile tags of the first type are shown as triangles, while mobile tags of the second type are shown as crosses. The position of the terminal device 250 is shown as a square.

In FIG. 8(a), the screen 810 also displays a selector menu 850. The selector menu 850 enables the user to display points having identifiers that correspond to a selected value. This alters the display on screen 810 of the display 270. In FIG. 8(b), ‘sel_1’ has been selected from the selector menu; thus the screen 810 only displays points that correspond to mobile tags 210 that have an identifier value of ‘sel_1’ in their position advertising messages. These points are the points identified by the triangle icon, and represent mobile tags 210 having the ‘sel_1’ identifier. To use the above example of a hospital, ‘sel_1’ could be a value associated with patients.

Conversely, if ‘sel_2’ has been selected by a user, the screen 810 only displays points that correspond to mobile tags 210 that have an identifier value of ‘sel_2’. These points are the points identified by the cross icon, and represent mobile tags 10 having the ‘sel_2’ identifier in their position advertising messages. To use the above example of a hospital, ‘sel_2’ could be a value associated with nurses.

A user can therefore filter the displayed position of mobile tags 210 according to their identifiers. This is especially useful when the number of mobile tags 210 is large, which, in turn, clutters a display of the locations of these devices within an area. After filtering the points, the user is able to get a clear idea of the location of mobile tags 210 (having a selected identifier) in relation to the terminal device 250. This may be especially useful for tracking patients or expensive pieces of hospital equipment, for example. As with the examples provided above, a map showing the features of a building or complex within the area may be provided on the screen 810 to enhance the information provided to the user.

If one or more mobile tags 210 are available in areas that are not covered by the terminal device 250, an external network may be used to provide the terminal device 250 with image data relating to these mobile tags 210.

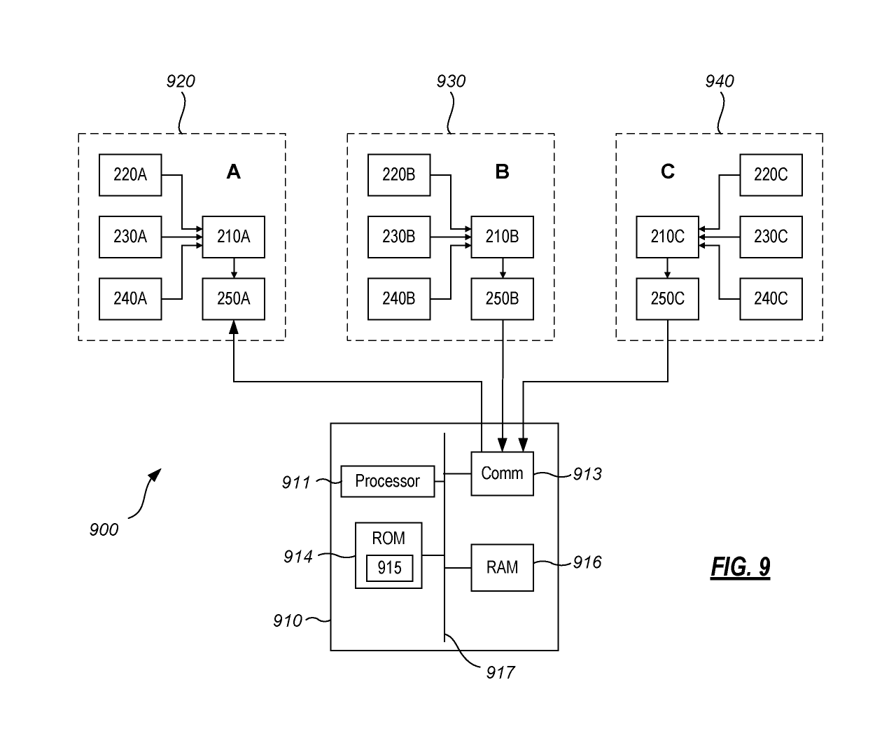

FIG. 9 shows several areas 920 (zone A), 930 (zone B) and 940 (zone C), each being mapped by a terminal device 250A, 250B, 250C in the respective areas. The respective terminal devices display the location of one of more mobile tags in each of the areas 920, 930 and 940. Thus terminal device 250A displays the location of mobile tag 210A in area 920, terminal device 250B displays the location of mobile tag 210B, and terminal device 250C displays the location of mobile tag 210C. The display of these locations may be done by any method as previously discussed. Each of the mobile tags 210A, 210B and 210C calculate their position relative to the respective fixed tags: mobile tag 210A calculates its position in area 920 relative to fixed tags 220A, 230B and 240C; mobile tag 210B calculates its position in area 930 relative to fixed tags 220B, 230B and 240B; and mobile tag 210C calculates its position in area 940 relative to fixed tags 220C, 230C and 240C.

The terminal device 250A displays the position of mobile tag 210A relative to the position of the terminal device 250A in area 920. In addition to this, terminal device 250A may be configured to additionally display the position of mobile tags 210B in area 930 and mobile tag 210C in area 940. This is done via an external network cloud 910.

The network cloud 910 includes a processor 911. The processor 911 is connected to volatile memory such as RAM 916 by a bus 917. The bus 917 also connects the processor 911 and the RAM 916 to non-volatile memory, such as ROM 914. A communications interface or module 913 is coupled to the bus 917, and thus also to the processor 911 and the memories 914, 916. Within the ROM 914 is stored a software application 915. The software application 915 in this embodiment is an application for relaying position data from between terminal devices 250A, 250B and 250C.

Terminal devices 250A, 250B and 250C send position data relating to the mobile tags 210A, 210B and 210C from which they have received BTLE messages with mobile tag position information to the cloud 910.

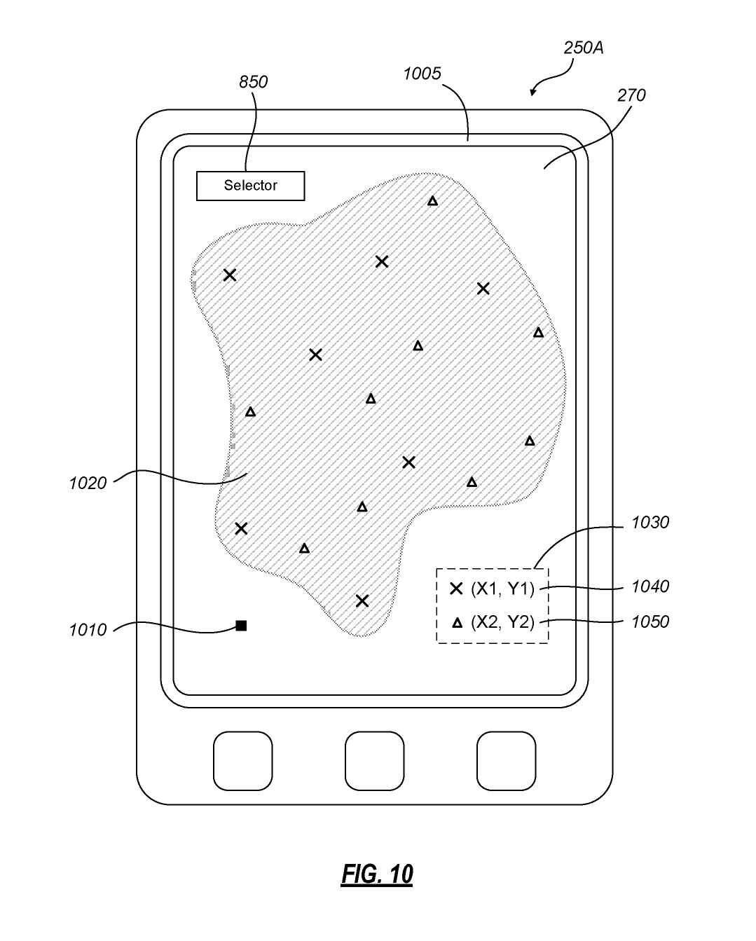

At any point, a terminal device, for example terminal device 250A, may request position data relating to a select group of mobile tags. Such a grouping may be specified by identifiers that are contained within header sections of the position data. FIG. 9 shows terminal devices 250B and 250C sending position data relating to mobile tags 210B and 210C in areas 930 and 940 to the cloud 910. The cloud 910 stores this position data in its RAM 916. Terminal device 250A may then request this position data from could 910 by requesting all data containing a specific identifier in the header portions. The application 915 then instructs the processor 911 of the cloud 910 to transmit the requested data via the communications interface 911. Terminal device 250A then displays the position of mobile tag 210A and the position of mobile tags 210B and 210C on its display for the user. Such a display is depicted in FIG. 10.

FIG. 10 illustrates an exemplary display 270 of terminal device 250A. The display 270 comprises at least a screen 1005. The screen 1005 displays the position of the terminal device 250A as point 1010 and points corresponding to mobile tags 210A of a various types, shown collectively as 1020, in the area covered by terminal device 250A (area 920 in FIG. 9). The position of the terminal device 250A is shown as a square. A selector menu 850 is also shown for the purposes as discussed above in relation to FIG. 8(a). Additionally, the display 270 also shows a section 1030 containing points 1040 and 1050 which relate to mobile devices 210B and 210C in areas external to area 920. From FIG. 9, mobile tag 210B is located in area 930 and mobile tag 210C is located in area 940. The position of each of these externally located mobile tags is shown as text in FIG. 10, but it will be understood that the positions of these tags may be displayed in accordance with any of the embodiments as discussed in relation to FIGS. 6 and 7. For example, maps of areas 930 and 940 may be shown in an inset in the display 270 to pictorially represent the position of mobile tags 210B and 210C in each of these areas.

According to embodiments of the present disclosure, terminal devices 250A, 250B and 250C may also send position data relating to the mobile tags 210A, 210B and 210C from which they have received BTLE messages with mobile tag position information to respective collector devices, each of which having a fixed position in each of areas 920, 930 and 940. Thus, mobile tag 210B may send its position data to a collector device having a fixed position within zone B. The respective collector devices send the position data to the network cloud 910 when requested by a terminal device (e.g. when requested by terminal device 250A as discussed in the above example). In this manner, the collector devices, and not the mobile tags, communicate with the network cloud 910.

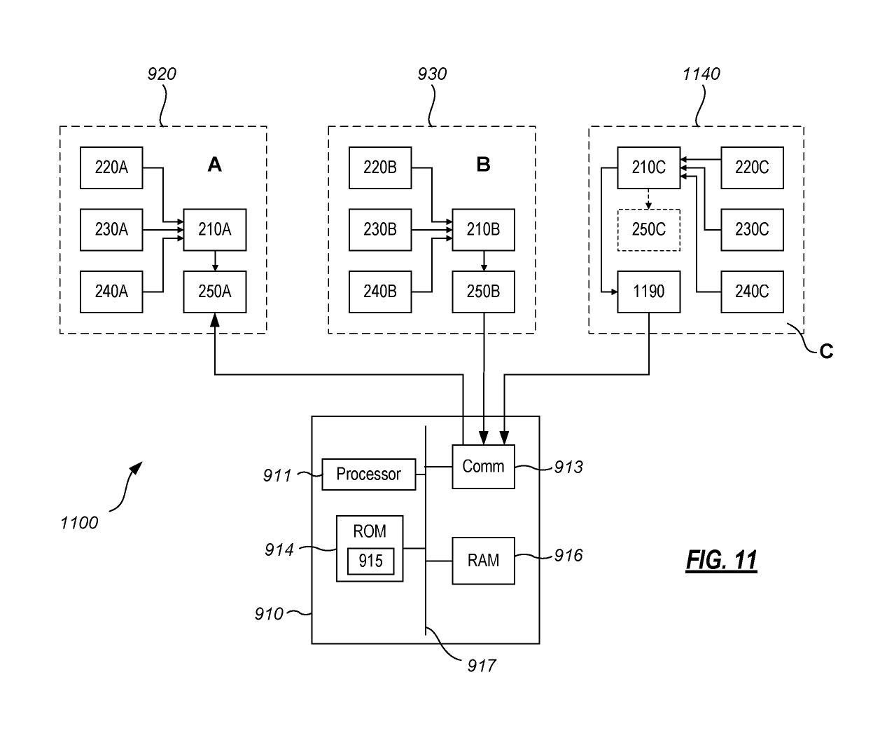

FIG. 11 shows a similar system to that shown in FIG. 9. However in FIG. 11, area 1140 (zone C) instead has a collector device 1190. Collector device 1190 in area 1140 has a fixed position in that it is attached to a fixed point in area 1140 (such as a wall, for example). Collector device 1190 receives position data relating to mobile tag 210C from mobile tag 210C. The collector device 1190 then sends the position data to the network cloud 910. In this manner, terminal device 250C is not needed to send the position data to the network cloud 910.

The collector device 1190 may take any suitable form. Generally speaking, the collector device, as with the fixed tags 220, may comprise processing circuitry, including one or more processors, and a storage device, comprising a single memory unit or a plurality of memory units. The storage device may store computer program instructions that, when loaded into the processing circuitry, control the operation of the collector device 1190.

Embodiments of the present disclosure may be applied to an augmented reality environment. Here the terminal device 250 may additionally be equipped with a camera which is able to capture images of the area covered by the terminal device 250. The terminal device 250 overlays these images with the position data obtained from the respective mobile tags 210 available in the area. This presents the user with a stream of images as the terminal device 250 is held by the user, the stream of images showing the position of mobile tags 210 in the area. It will be understood that the positions of these tags may be displayed in the augmented reality environment in accordance with any of the embodiments as discussed in relation to FIGS. 6, 7, 8 and 10.

Embodiments of the present disclosure may be implemented in software, hardware, application logic or a combination of software, hardware and application logic. The software, application logic and/or hardware may reside on memory, or any computer media. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer.

A computer-readable medium may comprise a computer-readable storage medium that may be any tangible media or means that can contain or store the instructions for use by or in connection with an instruction execution system, apparatus, or device, such as a computer as defined previously.

According to various embodiments of the previous aspect of the present disclosure, the computer program according to any of the above aspects, may be implemented in a computer program product comprising a tangible computer-readable medium bearing computer program code embodied therein which can be used with the processor for the implementation of the functions described above.

Reference to “computer-readable storage medium”, “computer program product”, “tangibly embodied computer program” etc, or a “processor” or “processing circuit” etc. should be understood to encompass not only computers having differing architectures such as single/multi processor architectures and sequencers/parallel architectures, but also specialised circuits such as field programmable gate arrays FPGA, application specify circuits ASIC, signal processing devices and other devices. References to computer program, instructions, code etc. should be understood to express software for a programmable processor firmware such as the programmable content of a hardware device as instructions for a processor or configured or configuration settings for a fixed function device, gate array, programmable logic device, etc.

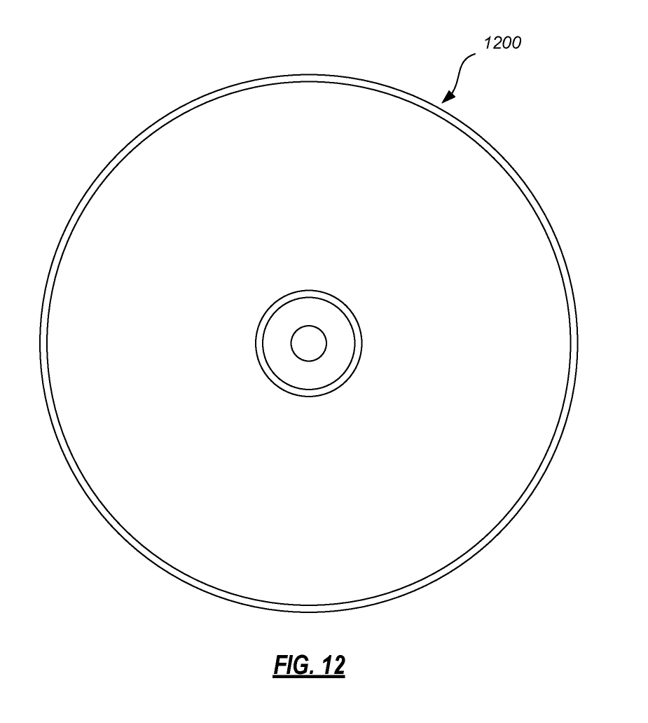

By way of example, and not limitation, such “computer-readable storage medium” may mean a non-transitory computer-readable storage medium which may comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. An exemplary non-transitory computer-readable storage medium 1200 is shown in FIG. 12, in the form of an optical storage disk such as a CD. Also, any connection is properly termed a “computer-readable medium”. For example, if to instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that “computer-readable storage medium” and data storage media do not include connections, carrier waves, signals, or other transient media, but are instead directed to non-transient, tangible storage media. Disk and disc, as used herein, include compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of “computer-readable medium”.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

If desired, the different steps discussed herein may be performed in a different order and/or concurrently with each other. Furthermore, if desired, one or more of the above-described steps may be optional or may be combined.

Although various aspects of the present disclosure are set out in the independent claims, other aspects of the present disclosure comprise other combinations of features from the described embodiments and/or the dependent claims with the features of the independent claims, and not solely the combinations explicitly set out in the claims.

1-85. (canceled)

86. A method performed at a first device, the method comprising:
receiving at least one Bluetooth Low Energy message transmitted from each of at least three second devices, each Bluetooth Low Energy message including data indicating a position of a respective one of the at least three second devices;
measuring a radio parameter for each of the received Bluetooth Low Energy messages;
calculating a position of the first device based on the radio parameters and the data included in the messages; and
transmitting a Bluetooth Low Energy message including data indicating the position of the first device.

87. The method according to claim 86, further comprising detecting, at a motion detector in the first device, whether the first device is moving.

88. The method according to claim 86, comprising using Bluetooth Low Energy messages from a predetermined number of the second devices from which strongest signals are received for calculating the position of the first device, if signals are received from the predetermined number of the second devices.

89. The method according to claim 86, wherein each second device has a fixed position.

90. The method according to claim 86, wherein the Bluetooth Low Energy message comprises several AD structures, each of which has an associated header,
wherein after receiving an AD structure as required by the first device, the first device terminates receiving a remaining portion of the Bluetooth Low Energy message.

91. The method according to claim 86, wherein the Bluetooth Low Energy message is a position advertising message.

92. The method according to claim 86, wherein the data indicating the position in the Bluetooth Low Energy message includes a latitude and a longitude of the respective device.

93. A method performed at a third device, the method comprising:
receiving at least one Bluetooth Low Energy message transmitted from each of at least three devices, each Bluetooth Low Energy message including data indicating a position of a respective one of the at least three devices;
measuring a radio parameter for each of the received Bluetooth Low Energy messages;
calculating a position of the third device using the radio parameters and the data included in the messages;
receiving at least one Bluetooth Low Energy message transmitted by a first device and including data indicating a position of the first device; and
displaying the position of the first device relative to the third device on a display of the third device.

94. The method according to claim 93, wherein the at least three devices includes the first device.

95. Apparatus comprising a first device, the first device comprising at least one processor, at least one memory, and computer-readable code stored on the at least one memory, wherein the computer-readable code when executed controls the at least one processor to perform a method comprising:
receiving at least one Bluetooth Low Energy message transmitted from each of at least three second devices, each Bluetooth Low Energy message including data indicating a position of a respective one of the at least three second devices;
measuring a radio parameter for each of the received Bluetooth Low Energy messages;
calculating a position of the first device using the radio parameters and the data included in the messages; and
transmitting a Bluetooth Low Energy message including data indicating the position of the first device.

96. The apparatus of claim 95, wherein the computer-readable code when executed controls the at least one processor to perform:
detecting whether the first device is moving.

97. The apparatus of claim 96, wherein detecting motion of the first device is performed by a motion detector in the first device,
wherein the computer-readable code when executed controls the at least one processor to perform position calculation more frequently if it is detected that the first device transitions to a moving state.

98. The apparatus of claim 95, wherein the computer-readable code when executed controls the at least one processor to perform:
using Bluetooth Low Energy messages from a predetermined number of second devices from which strongest signals are received for calculating the position of the first device if signals are received from the predetermined number of second devices.

99. The apparatus of claim 95, wherein each second device has a fixed position.

100. The apparatus of claim 95, wherein the Bluetooth Low Energy message comprises several AD structures, each of which has an associated header,
wherein the computer-readable code when executed controls the at least one processor to perform, after receiving an AD structure as required by the first device, terminating receiving the remaining portion of the Bluetooth Low Energy message.
